(19) United States
(12) Patent Application Publication
(10) Pub. No.: US 2007/0085671 A1
(43) Pub. Date: Apr. 19, 2007

(54) APPARATUS AND METHOD FOR PROVIDING A PROGRAMMABLE CHIME FOR SECURITY SYSTEM PROXIMITY ALERTS

(75) Inventors: Christopher D Martin, Plainview, NY (US); Narine Boodoosingh, Ozone Park, NY (US); Kevin G Piel, Ronkonkoma, NY (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., MORRISTOWN, NJ (US)

(21) Appl. No.: 11/163,339

(22) Filed: Oct. 14, 2005

(51) Int. Cl. G08B 23/00; G08B 13/00

(52) U.S. Cl. 340/517; 340/541

(57) ABSTRACT

A security system that includes provisions for alarm faults for the premises surrounding a building which includes a security panel including a microprocessor and memory, the security panel has an armed mode and a disarmed mode. The apparatus further includes a plurality of sensors disposed outside of a building, each of the sensors has an alarm fault condition and a no alarm fault condition and the security panel is programmable to produce a first set of responses to an alarm fault condition on any one or more of the plurality of sensors when the security panel is armed and to produce a second set of responses to an alarm fault condition on any one or more of the plurality of sensors when the security panel is disarmed. The invention also includes the method for improving the security of the premises surrounding the building which includes providing a security panel including a microprocessor and memory and having an armed mode and a disarmed mode; providing a plurality of sensors, having an alarm fault condition and a no alarm fault condition, disposed outside of a building; providing programmability in the security panel to produce a first set of responses to an alarm fault condition from any one or more of said plurality of sensors when said security panel is armed and to produce a second set of responses to an alarm fault condition when an alarm fault condition occurs in any one or more of the plurality of sensors when said security panel is disarmed.

### BACKGROUND OF THE INVENTION

The invention relates to security systems for residential and commercial buildings and particularly to security systems utilizing proximity sensors to identify the movement of persons or other animate objects within a secured area.

Most security systems today have chime modes whereby the keypad will beep three times when a zone within a protected building or area is faulted while system is disarmed. Some systems also include the ability to deliver a verbal audio message when chime event occurs. Security systems have not, however, allowed the user to pre-select how the chime mode functions when the security system is armed and disarmed.

### SUMMARY OF THE INVENTION

A primary object of the present invention is to provide more specific information to a homeowner, a building owner, or a building occupant etc. about the location of any intruder that may be on the property such as at the front door, the backdoor, the side window, the front window, in the yard etc. when the system is armed.

It is an object of the present invention to provide a security system that allows the user to pre-select how the chime mode functions when the security system is either armed or disarmed.

Another object of the present invention is to provide a method and apparatus enabling a user to pre-select individual chime responses for respective proximity sensors.

Still another object invention is to provide a method and apparatus enabling a user to pre-select individual chime responses for respective proximity sensors located around the perimeter of a home or yard.

It has now been found that these and other objects of the invention may be attained in a security system that includes provisions for alarm faults for the premises surrounding a building which includes a security panel including a microprocessor and memory, the security panel has an armed mode and a disarmed mode. The apparatus further includes a plurality of sensors disposed outside of a building, each of the sensors has an alarm fault condition and a no alarm fault condition and the security panel is programmable to produce a first set of responses to an alarm fault condition on any one or more of the plurality of sensors when the security panel is armed and to produce a second set of responses to an alarm fault condition on any one or more of the plurality of sensors when the security panel is disarmed.

In some forms of the security system, at least some of the plurality of sensors include a camera associated therewith and the security panel is programmable to direct an image from a camera associated with a given sensor when that given sensor is in an alarm fault condition and the security panel is in an armed mode.

The security system may further have a structure where and at least some of the plurality of sensors include a camera associated therewith and the security panel is programmable to direct an image from a camera associated with a given sensor when that given sensor is in an alarm fault condition and the security panel is either armed mode or disarmed mode.

The security panel may be programmable to permit the users to selectively deliver alarm fault responses from any one of the sensors in the form of an audible chime and the security panel may be programmable to provide different responses dependent on whether the security panel is in armed or disarmed mode.

The security system may include a security panel that is programmable to permit the user to selectively deliver alarm fault responses from any one of the sensors in the form of a predetermined audible voice message and the security panel is programmable to provide different responses dependent on whether the security panel is in armed or disarmed mode. The security system may include a security panel that is programmable to permit the users to selectively deliver alarm fault responses from any one of the sensors in the form of a predetermined volume and the security panel is programmable to provide different responses having different volumes dependent on whether the security panel is in armed or disarmed mode.

Some forms of the security system may include a security panel that is programmable to permit the users to selectively deliver alarm fault responses from any one of the sensors in the form to a message delivery system selected from the group consisting of telephone, Internet and other communications networks and the security panel is programmable to provide different responses dependent on whether the security panel is in armed or disarmed mode.

The security system may include a security panel that is programmable to permit the users to selectively deliver alarm fault responses from any one of the sensors to a message delivery system selected from the group consisting of telephone, Internet and other communications networks and the security panel is programmable to provide different responses dependent on whether the security panel is in armed or disarmed mode. The security system has in some cases a security panel that is programmable to permit the users to selectively deliver alarm fault responses from any one of the sensors in the form to a message delivery system selected from the group consisting of the telephone, Internet and other communications networks and the security panel is programmable to provide different responses dependent on whether the security panel is in armed or disarmed mode.

In some cases the security system may include a security panel that is programmable to permit the user to provide different responses to a fault alarm dependent on whether the security panel is in armed or disarmed mode and a least one of the responses includes transmitting an alarm signal until a predetermined event occurs selected from the group consisting of a predetermined time interval elapses and the user resets the system.

The invention also includes the method for improving the security of the premises surrounding the building which includes providing a security panel including a microprocessor and memory and having an armed mode and a disarmed mode; providing a plurality of sensors, having an alarm fault condition and a no alarm fault condition, disposed outside of a building; and providing programmability in the security panel to produce a first set of responses to an alarm fault condition from any one or more of the plurality of sensors when the security panel is armed and to produce a second set of responses to an alarm fault condition when an alarm fault condition occurs in any one or more of the plurality of sensors when the security panel is disarmed.

In some forms of the method the step of providing a plurality of sensors includes providing at least some of the plurality of sensors include a camera associated therewith and the step of providing a security panel includes providing a security panel that is programmable to direct an image from a camera associated with a given sensor when that given sensor is in an alarm fault condition and the security panel is in an armed mode. The method may include a step of providing a plurality of sensors that includes providing a camera associated with at least some of the plurality of sensors and the step of providing a security panel includes providing a security panel that is programmable to direct an image from a camera associated with a given sensor when that given sensor is in an alarm fault condition and the security panel is either armed mode or disarmed mode.

The method includes the step of providing a security panel that includes providing a security panel that is programmable to permit the users to selectively deliver alarm fault responses from any one of the sensors in the form of an audible chime and the step of providing a security panel that is programmable to provide different responses dependent on whether the security panel is in armed or disarmed mode in some forms of the present invention. The method may include the step of providing a security panel that includes providing a security panel that is programmable to permit the users to selectively deliver alarm fault responses from any one of the sensors in the form of a predetermined audible voice message and includes providing a security panel that is programmable to provide different responses dependent on whether the security panel is in armed or disarmed mode.

In some forms of the method of providing a security system the step of providing a security panel includes providing a security panel that is programmable to permit the users to selectively deliver alarm fault responses from any one of the sensors having a predetermined volume and the step of providing a security panel includes providing a security panel that is programmable to provide different responses having different volumes dependent on whether the security panel is in armed or disarmed mode.

The method of providing a security system includes the step of providing a security panel that includes the step of providing a security panel that is programmable to permit the users to selectively deliver alarm fault responses from any one of the sensors in the form of a message delivery system selected from the group consisting of telephone, Internet and other communications networks and the method of providing a security panel includes providing a security panel that is programmable to provide different responses dependent on whether the security panel is in armed or disarmed mode.

In some forms of the method of providing a security system the step of providing a security panel includes providing a security panel that is programmable to permit the users to selectively deliver alarm fault responses from any one of the sensors to a message delivery system selected from the group consisting of telephone, Internet and other communications networks and the step of providing a security panel includes providing a security panel that is programmable to provide different responses dependent on whether the security panel is in armed or disarmed mode.

Some forms of the method of providing a security system include the step of providing a security panel that includes providing a security panel that is programmable to permit the users to selectively deliver alarm fault responses from any one of the sensors in the form to a message delivery system selected from the group consisting of telephone, Internet and other communications networks and the security panel is programmable to provide different responses dependent on whether the security panel is in armed or disarmed mode. The method of providing a security system may include the step of providing a security panel that includes providing a security panel that is programmable to permit the users to selectively program different responses to a fault alarm dependent on whether a security panel is in armed or disarmed mode and the method for providing a security panel further includes providing at least one of the responses further includes transmitting an alarm signal until a predetermined event occurs selected from the group consisting of a predetermined time interval elapses and the user resets the system.

### BRIEF DESCRIPTION OF THE DRAWING

The invention will better understood by reference to accompanying drawing in which:

FIG. 1 is a diagrammatic view of one form of the present invention and particularly a building having proximity sensors at a plurality of locations about the building and

FIG. 2 is a schematic block diagram of a security system in accordance with one form of the present invention.

### DESCRIPTION OF THE PREFERRED EMBODIMENTS

There is a variety of security systems intended for homeowners, business owners, and other potential targets for burglary, that are monitored by a central station. These systems are vastly superior to older systems that merely sound a bell or alarm. They have also largely replaced systems that were tied in directly to the local police station. As the use of burglar alarms increased, the local police departments began turning down more and more requests to be “hooked-up.” As a result, there became a demand for central stations, or companies whose specialty it was to simply monitor burglar alarms. Most police departments will still allow banks and large jewelry stores a direct link to the police station, but as a rule, homeowners are excluded. So as the demand for security has risen, many guard agencies and burglar alarm installers have begun to offer centralized monitoring as an option for their clients.

When such systems are installed, it is common for them to be connected by a dedicated telephone line to the central station. Other systems utilize radio frequency and the internet to connect to the central station. In the event of an intrusion, the alarm panel (also known as a security panel or control panel) on the premises being monitored calls up the central station and gives an electronic message to the answering computer. It tells the computer exactly which switch or sensor has been violated, and the computer then tells the operator what has happened. For example, if a burglar entered through a broken window, the panel would connect with the computer and tell it that zone 4, a first floor window, has been broken. The operator would then see on his computer screen a display indicating, for example, that in the Johnson residence, in zone 4, the foil on the living room window, violated. As the thief progresses through the house, the panel would call the computer for every sensor that was violated. The operator may then receive status that in zone 17, a passive Infrared detector in the master bedroom, has detected someone. In some cases, pre-amplified microphones allow audio monitoring of the protected premises. The operator would then be fairly sure someone was in the house, so the operator would have three options. The operator may just send the companies guards to the scene, call 911 and dispatch the police, or the operator may send both the police and the guards.

The term “proximity sensor” as used herein includes but is not limited to ultrasonic sensors, diffuse-mode optical proximity sensors and passive infrared sensors. For convenience, a preferred embodiment of the present invention will be with respect to a passive infrared sensor. Passive infrared (PIR) alarms are so called because they do not emit Infrared energy, but merely detect a change in Infrared energy. A PIR sensor probes its monitoring area, and if any changes are detected in Infrared (heat), it triggers an alarm. A PIR records the ambient room temperature so it will notice any changes in IR such as those that are produced by the human body. Slow temperature changes, such as thermostatically controlled heating systems, will not interfere with the PIR's function.

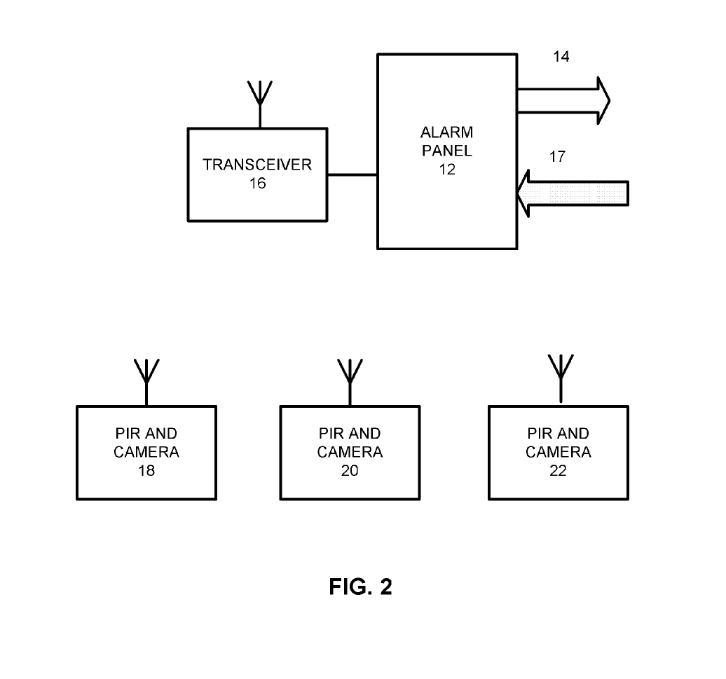

Referring now to the drawings, there is shown in FIG. 2 three conventional sensors, namely passive infrared (PIR) sensors 18, 20, and 22 having a day camera associate therewith. The sensors 18, 20, and 22 include a battery and an internal transmitter and an antenna for transmitting a signal corresponding to the sensed parameter. Commercially available passive infrared sensors (without the camera) of this type are manufactured and sold by Honeywell and identified by the designation Ademco 5890 or 5894. The addition of a camera is well within the skill in the art. Customarily the wireless sensor 2 is constructed and programmed to issue a signal at a predetermined interval to confirm the presence and operability of the sensor 2. For example, such a signal may be sent at an interval of once every hour to confirm to an alarm panel that the sensor has not been stolen or become inoperative.

The respective signals from the sensors 18, 20, 22 are transmitted to a receiver 16 that is configured to receive the signal from the respective sensors. Commercially available devices of this type (without the video feed supplied by the camera) are manufactured by Honeywell and are identified by the designation Ademco 5881. The addition of apparatus for transmitting and receiving the video feed is well within the skill in the art.

The receiver 16, in the preferred embodiment is physically connected to an alarm panel 12. A commercially available alarm panel 12 for such an application is manufactured by Honeywell and identified by the designation VISTA 50-P.

Typically, the alarm panel 12 includes a computer that includes a microprocessor and memory and which cooperates with software that is commercially available or within the skill of practitioners in the programming arts given the description herein and which is well known in the art. The alarm panel 12 is coupled by a phone line to a microcomputer running control software whereby the alarm panel 12 may be remotely controlled. One commercially available software program for such purposes is marketed by Honeywell and identified as the Ademco Compass Downloader. This software permits a user to remotely program and control an alarm system. The user may do so from the comfort of an office and will allow the user to download and upload alarm control information, to compare the upload and saved information, and to view the results either on a screen or any printed report. The Compass Downloader enables programming from an office prior to installation. Alternatively, initial programming can be downloaded from a remote location or at a job site using a personal computer with a commercially available serial module such as the Honeywell/Ademco 4100SM (where the alarm panel supports it).

The Ademco Compass Downloader for Windows Software is network compatible software that provides a quick and easy method for planning, designing and communicating with the alarm panels. With this software the user can upload system programming that has been manually entered into the panel, or previously downloaded. The Compass change feature reviews all system changes initiated by the download operator within the current session. A complete record of system modifications and the history of an account are also available.

As noted above each of the sensors 18, 20, 22 is a wireless sensor that communicates with a transceiver 16 coupled to an alarm panel 12. Although the illustrated embodiment utilizes wireless sensor cooperating with a transceiver 16, those skilled in the art will recognize that sensors may also be hardwired to the alarm panel 12. The alarm panel 12 has incoming communication 17 and outgoing communication 14 via telephone, Internet or other communications networks such as the ALARMNET communications system. The ALARMNET communications network is a nationwide service provider delivering a wide range of products and services for supervised alarm signal transport applications. The ALARMNET communications network is operated by Honeywell.

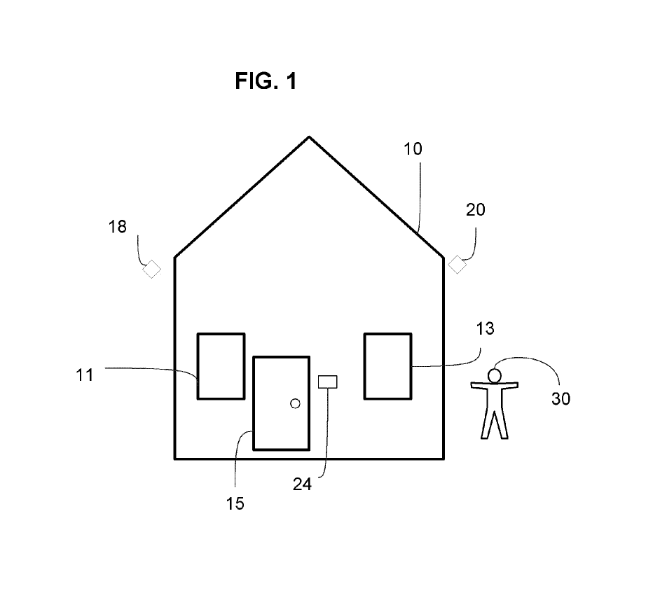

This invention will introduce a new “Proximity Chime” mode that will be used for protection zones installed primarily on the outside of a home as best seen in FIG. 1 in which a building 10 is provided with passive infrared sensors 18, 20 on oppose size of the building 10. The building is provided with windows 11, 13 and a door 15. The security system for the building includes the apparatus illustrated in FIG. 2 in addition to a keypad control 24 disposed near the door 16. The keypad 24 may be connected wirelessly to the alarm panel 12 by means of the transceiver 16 or alternatively may be hardwired to the alarm panel 12. The purpose of the present apparatus is to give the homeowner, having such a system installed, better information regarding the existence of an intruder as well as a much more precise indication of the location of any such intruder that may be on the property such as at the front door or in the yard when the system is armed. Thus, an intruder 30, as illustrated in FIG. 1, will be perceived by the proximity sensor 20 and a response will be produced in accordance with the programmed instructions all of the user.

A typical system in accordance with the present invention will included a plurality of motion detectors placed strategically around the exterior premises. In a preferred embodiment the motion detectors will be placed in a plurality of locations about the exterior surface of the protected building as well as at various locations on the premises surrounding the building. The security system in one form of the present invention will include a zone list corresponding to the respective proximity sensors. Typical security system panels include a microprocessor, memory, and a data bus connecting the memory and the microprocessor. It is well within the skill the art to provide software control that allows the owner or other person in charge of a given building to program the security system to provide unique unambiguous audible signals for each of the respective motion sensors. In one embodiment of the present invention a central-station in which there is disposed microprocessor (not shown) coupled to the inputs 17 and outputs 14 is instructed to provide specific responses to each of the respective sensors such as 18, 20, and 22. The responses when the security system is alarmed may include, although not limited to the specific responses, notifying the owner, notifying a neighbor, notifying a security guard, notifying the police, initiating an audible chirp or siren, sending a unique report to pager, sending a text message, sending an email, sending a video clip (in the case of those embodiments that include a camera in the respective motion sensors), and/or initiating an audible verbal message such as: “unauthorized access leave immediately.”

In some embodiments of the present invention the security system will be programmed to produce a unique audible signal at the keypad 24 in response to an alarm condition at any one of the sensors such as 18, 20, or 22. Preferably, the user will be able to program the volume of the respective audible signals at the keypad to insure the user is able to consciously predetermined if he or she wishes to me woken up in response to alarm condition, whether the audible alarm at the keypad repeats a fixed number of times after alarm condition, whether the audible alarm at the keypad continues indefinitely after an alarm condition at any sensor occurs, whether the audible alarm continues until the keypad is reset, the volume of the respective alarms at the keypad to permit a user to adjust the sound level that will attain the user's attention without “alarming” the user by the mere magnitude of the sound, whether an audible alarm with a specific verbal message such as: “Motion in Backyard”, whether the keypad keeps the fault displayed on the keypad until reset by the user etc. The latter example it is desirable in the event a user does not hear the alarm, such as when he or she is not in the building, and the user desires the benefit of being informed as to the full occurring in his or her absence.

When the security system is disarmed most embodiments of the present invention will have a more limited output to inform the user of alarm events. For example, in some embodiments, the system may provide only a standard chime option only with three beeps and an audible voice statement.

Various embodiments of the present invention may be independent of a conventional alarm system or a part of a conventional alarm system that will provide a maximum response that includes initiating sirens and dispatching security and/or police personnel. Even in such conventional alarm systems that can provide such a maximum response, the features of the present invention may merely produce a chime in a keypad within a protected building and or produce an audible warning outside of the building such as “Your presence has been detected. Leave immediately. Police will be called.” Some embodiments of the present invention include a zone response that differs for each zone depending whether the system is in AWAY, STAY or DISARMED mode.

While the present invention has been described primarily with respect to motion sensors disposed outside of building, those skilled in the art will recognize that various embodiments of the present invention may comprise part of an integrated system that include sensors within a building as well as outside of a building. Similarly, those skilled in the art will recognize that this system in accordance with a preferred embodiment of the invention utilizes proximity sensors, however, other embodiments may utilize other sensors such as panic switches, glassbreak switches, conventional magnetic contact switches, inductive proximity switches, vibration sensors, photoelectric proximity switches, capacitive proximity switches, shock sensors etc.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompass other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A security system that includes provisions for alarm faults for the premises surrounding a building which comprises:
a security panel including a microprocessor and memory, said security panel having an armed mode and a disarmed mode;
a plurality of sensors disposed outside of a building, each of said sensors having an alarm fault condition and a no alarm fault condition,
said security panel being programmable to produce a first set of responses to an alarm fault condition on any one or more of said plurality of sensors when said security panel is armed and to produce a second set of responses to an alarm fault condition on any one or more of said plurality of sensors when said security panel is disarmed.

2. A security system as described in claim 1 wherein at least some of said plurality of sensors includes a camera associated therewith and said security panel is programmable to direct an image from a camera associated with a given sensor when that given sensor is in an alarm fault condition and said security panel is in an armed mode.

3. A security system as described in claim 1 wherein at least some of said plurality of sensors includes a camera associated therewith and said security panel is programmable to direct an image from a camera associated with a given sensor when that given sensor is in an alarm fault condition and said security panel is either armed mode or disarmed mode.

4. A security system as described in claim 1 wherein said security panel is programmable to permit the users to selectively deliver alarm fault responses from any one of said sensors in the form of an audible chime and said security panel is programmable to provide different responses dependent on whether said security panel is in armed or disarmed mode.

5. A security system as described in claim 1 wherein said security panel is programmable to permit the users to selectively deliver alarm fault responses from any one of said sensors in the form of a predetermined audible voice message and said security panel is programmable to provide different responses dependent on whether said security panel is in armed or disarmed mode.

6. A security system as described in claim 1 wherein said security panel is programmable to permit the users to selectively deliver alarm fault responses from any one of said sensors in the form of a predetermined volume and said security panel is programmable to provide different responses having different volumes dependent on whether said security panel is in armed or disarmed mode.

7. A security system as described in claim 1 wherein said security panel is programmable to permit the users to selectively deliver alarm fault responses from any one of said sensors in the form to a message delivery system selected from the group consisting of telephone, Internet and other communications networks and said security panel is programmable to provide different responses dependent on whether said security panel is in armed or disarmed mode.

8. A security system as described in claim 6 wherein said security panel is programmable to permit the users to selectively deliver alarm fault responses from any one of said sensors to a message delivery system selected from the group consisting of telephone, Internet and other communications networks and said security panel is programmable to provide different responses dependent on whether said security panel is in armed or disarmed mode.

9. A security system as described in claim 1 wherein said security panel is programmable to permit the users to selectively deliver alarm fault responses from any one of said sensors in the form to a message delivery system selected from the group consisting of telephone, Internet and other communications networks and said security panel is programmable to provide different responses dependent on whether said security panel is in armed or disarmed mode.

10. A security system is described in claim 1 wherein said security panel is programmable to permit the users to selectively programmable to provide different responses to a fault alarm dependent on whether said security panel is in armed or disarmed mode and a least one of said responses includes transmitting an alarm signal until a predetermined event occurs selected from the group consisting of a predetermined time interval elapses and the user resets the system.

11. A method for improving the security of the premises surrounding the building which comprises:
providing a security panel including a microprocessor and memory and having an armed mode and a disarmed mode;
providing a plurality of sensors, having an alarm fault condition and a no alarm fault condition, disposed outside of a building;
providing programmability in the security panel to produce a first set of responses to an alarm fault condition from any one or more of said plurality of sensors when said security panel is armed and to produce a second set of responses to an alarm fault condition when an alarm fault condition occurs in any one or more of the plurality of sensors when said security panel is disarmed.

12. The method as describing claim 11 wherein the step of providing a plurality of sensors includes providing at least some of said plurality of sensors included a camera associated therewith and the step of providing a security panel includes providing a security panel that is programmable to direct an image from a camera associated with a given sensor when that given sensor is in an alarm fault condition and said security panel is in an armed mode.

13. The method as described in claim 11 wherein the step of providing a plurality of sensors includes providing a camera associated with at least some of said plurality of sensors and the step of providing a security panel includes providing a security panel that is programmable to direct an image from a camera associated with a given sensor when that given sensor is in an alarm fault condition and said security panel is either armed mode or disarmed mode.

14. The method as described in claim 11 wherein said step of providing a security panel includes providing a security panel that is programmable to permit the users to selectively deliver alarm fault responses from any one of said sensors in the form of an audible chime and providing a security panel is programmable to provide different responses dependent on whether said security panel is in armed or disarmed mode.

15. The method as described in claim 11 wherein the step of providing a security panel includes providing a security panel that is programmable to permit the users to selectively deliver alarm fault responses from any one sensors in the form of a predetermined audible voice message and includes providing a security panel that is programmable to provide different responses dependent on whether the security panel is in armed or disarmed mode.

16. A method of providing a security system as described in claim 11 wherein said step of providing a security panel includes providing a security panel that is programmable to permit the users to selectively deliver alarm fault responses from any one of said sensors having a predetermined volume and the step of providing a security panel includes providing a security panel that is programmable to provide different responses having different volumes dependent on whether said security panel is in armed or disarmed mode.

17. The method of providing a security system as described in claim 11 wherein the step of providing a security panel includes providing a security panel that is programmable to permit the users to selectively deliver alarm fault responses from any one of the sensors in the form to a message delivery system selected from the group consisting of telephone, Internet and other communications networks and the method of providing a security panel includes providing a security panel that is programmable to provide different responses dependent on whether the security panel is in armed or disarmed mode.

18. The method of providing a security system as described in claim 11 wherein the step of providing a security panel includes providing a security panel that is programmable to permit the users to selectively deliver alarm fault responses from any one of said sensors to a message delivery system selected from the group consisting of telephone, Internet and other communications networks and the step of providing a security panel includes providing a security panel that is programmable to provide different responses dependent on whether said security panel is in armed or disarmed mode.

19. The method of providing a security system as described in claim 11 wherein the step of providing a security panel includes providing a security panel that is programmable to permit the users to selectively deliver alarm fault responses from any one of the sensors in the form to a message delivery system selected from the group consisting of telephone, Internet and other communications networks and said security panel is programmable to provide different responses dependent on whether said security panel is in armed or disarmed mode.

20. The method of providing a security system as described in claim 11 wherein said the step of providing a security panel includes providing a security panel that is programmable to permit the users to selectively program different responses to a fault alarm dependent on whether a security panel is in armed or disarmed mode and the method for providing a security panel includes providing at least one of said responses includes transmitting an alarm signal until a predetermined event occurs selected from the group consisting of a predetermined time interval elapses and the user resets the system.
